(19) United States
(12) Patent Application Publication
(10) Pub. No.: US 2008/0142769 A1
(43) Pub. Date: Jun. 19, 2008

(54) Control apparatus for carrying a heavy object

(76) Inventor: Chien-Kuo Liang, Chung-Ho City (TW)

Correspondence Address: TROXELL LAW OFFICE PLLC, 5205 LEESBURG PIKE, SUITE 1404, FALLS CHURCH, VA, 22041, US

(21) Appl. No.: 11/640,246

(22) Filed: Dec. 18, 2006

(51) Int. Cl. B66F 3/24; B66F 3/25

(52) U.S. Cl. 254/93 A; 254/93 R

(57) ABSTRACT

A control apparatus for carrying a heavy object is composed of a base which is connected with an elastic assembly that can move upward and downward, and the elastic assembly which is provided with an upper plate for loading the heavy object. By an upward displacement of the elastic assembly, the upper plate can push up the heavy object, and by a downward displacement of the elastic assembly, the upper plate of the elastic assembly can be escaped from the heavy object, and the heavy object can be escaped from the elastic assembly and the base, such that during a process of moving or transporting the heavy object, the heavy object can be quickly, conveniently, and safely escaped from or slid into the base, and in the mean time, a displacement of a weight-lifting vehicle or a crane can be eliminated upon being loaded with the heavy object.

### BACKGROUND OF THE INVENTION

a) Field of the Invention

The present invention relates to a control apparatus for carrying a heavy object, and more particularly to a control apparatus which can push up and put down a heavy object conveniently and safely without using heavy machinery.

b) Description of the Prior Art

A heavy object, such as an industrial computer cabinet, a server cabinet, an industrial machine, a food machine, a refrigerator, or a large-scale air conditioner, is provided with a weight of at least 50 kg. In moving or transporting these heavy objects, their displacements are assisted by a carrying with manpower, a push-up vehicle, or a weight-lifting vehicle. When working environment of the displacement is limited, the weight-lifting or push-up vehicle cannot be used, and thus the heavy object is not able to be displaced effectively.

Moreover, vibration force resulted from transporting, loading and unloading the heavy object by the weight-lifting vehicle or a crane will usually destroy a structure of the heavy object and its parts such as stands, or pulleys. Therefore, the internal components of the heavy object are displaced and damaged from the vibration.

Accordingly, how to design a control apparatus for carrying the heavy object, which is small in size, safe and convenient in operation, and vibration-proof, to push up and put down the heavy object, as well as to protect the heavy object from the vibration, is a technical issue to be solved by the present invention.

### SUMMARY OF THE INVENTION

The primary object of present invention is to provide a control apparatus for carrying a heavy object, which includes a base and an elastic assembly that can move upward and downward. The elastic assembly is installed on the base, and the heavy object is loaded on the elastic assembly. The heavy object can be pushed up by easily operating the elastic assembly to move upward, and the elastic assembly can be separated from the heavy object by operating the elastic assembly to move downward, such that the heavy object can be put down on a working interface, thereby enabling the heavy object to be pushed up and put down in a narrow space of working environment, and allowing the heavy object to be quickly, conveniently, and safely escaped from or slid into the base during moving or transporting, and in a mean time, eliminating a displacement of a weight-lifting vehicle or a crane in loading the heavy object.

Another object of the present invention is provide a control apparatus for carrying a heavy object, wherein the heavy object is positioned on an upper plate of an elastic assembly which is provided with a vibration-proof effect, so as to prevent the heavy object from being damaged due to the vibration.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention being loaded with a heavy object.

FIG. 2 shows an exploded view of components of the present invention for carrying a heavy object.

FIG. 3 shows a perspective view of an operation that a heavy object is entering into a base of the present invention.

FIG. 4 shows a sectional view that an elastic assembly of the present invention has not yet pushed up a heavy object.

FIG. 5 shows a sectional view that an elastic assembly of the present invention has already pushed up a heavy object.

FIG. 6 shows another sectional view that an elastic assembly of the present invention has already pushed up a heavy object.

FIG. 7 shows a sectional view of an embodient of the present invention that an air cushion is filled with liquid.

FIG. 8 shows an exploded view of another embodient of an elastic assembly of the present invention.

FIG. 9 shows a perspective view of the elastic assembly in FIG. 8 being assembled with a base.

FIG. 10 shows an exploded view of components in FIG. 9.

FIG. 11A shows a sectional view of an operation that the elastic assembly in FIG. 9 is pushed up.

FIG. 11B shows a sectional view of an operation that the elastic assembly in FIG. 9 is descended.

FIG. 12 shows an exploded view of another embodient of an elastic assembly of the present invention being assembled with a base.

FIG. 13 shows a top view of FIG. 12 after assembling.

FIG. 14 shows a longitudinal cutaway view along an I-I′ line in FIG. 13.

### DETAILED DESCRIPTION OF THE PREFERRED EMBODIMENTS

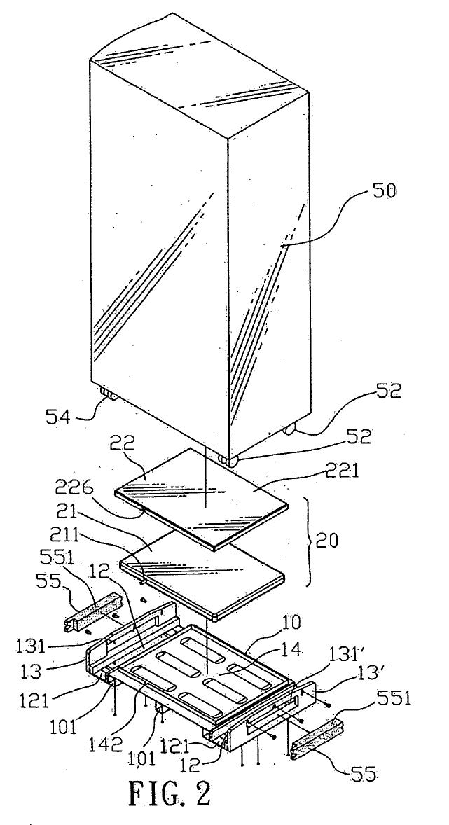

Referring to FIGS. 2, 10, and 12, the present invention is to provide a control apparatus for carrying a heavy object, constituting by a base 10 which is connected with a set of elastic assembly 20 that can move upward and downward; and the elastic assembly 20, an upper plate 22, 24 of which is loaded with a heavy object 50. By an upward displacement of the elastic assembly 20, the upper plate 22, 24 can push up the heavy object 50, and by a downward displacement of the elastic assembly 20, the upper plate 22, 24 of the elastic assembly 20 can be separated from the heavy object 50, such that the heavy object 50 can be escaped from the elastic assembly 20 and the base 10.

Referring to FIGS. 2, 3, 4, and 5, it shows a preferred embodiment of the present invention, wherein a center of the base 10 is provided with a sink 14 for installing the elastic assembly 20 which includes an air cushion 21. An interior space of the air cushion 21 is provided with high-pressure gas 100 which can be charged or discharged, such that volume of the air cushion 21 can be expanded or compressed at proper time; and an upper plate 22 which is provided with an upper surface 221 and is loosely sheathed on a surface of the air cushion 21. When the air cushion 21 is inflated, the volume of the air cushion 21 is expanded in the sink 14 to move upward, and the upper plate 22 is ascended vertically to push up the heavy object 50. On the other hand, when the air cushion 21 is deflated, its volume is compressed in the sink 14 to move downward, and the upper plate 22 is descended vertically and is escaped from a bottom 54 of the heavy object 50.

Referring to FIG. 2, a bottom of the base 10 is fixed with a plurality of beams 101 to increase intensity of the entire base 10.

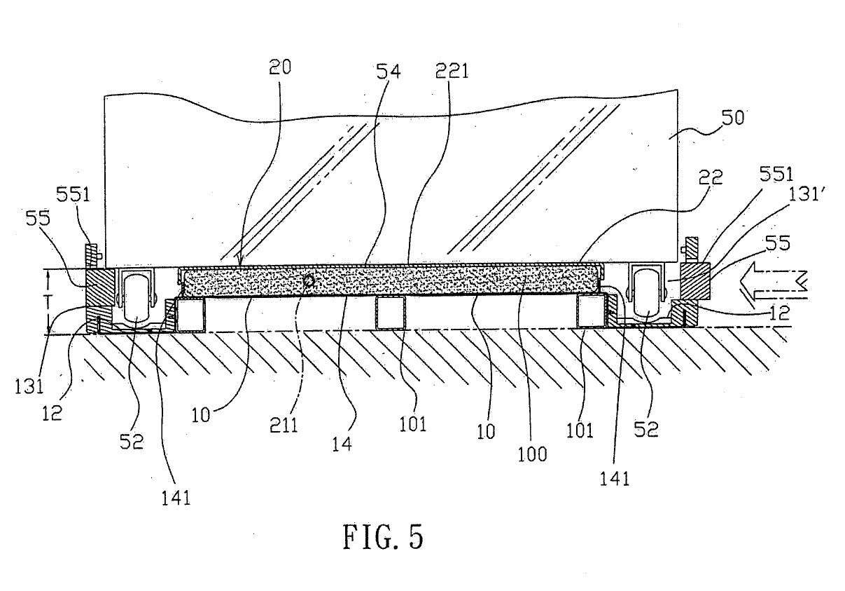

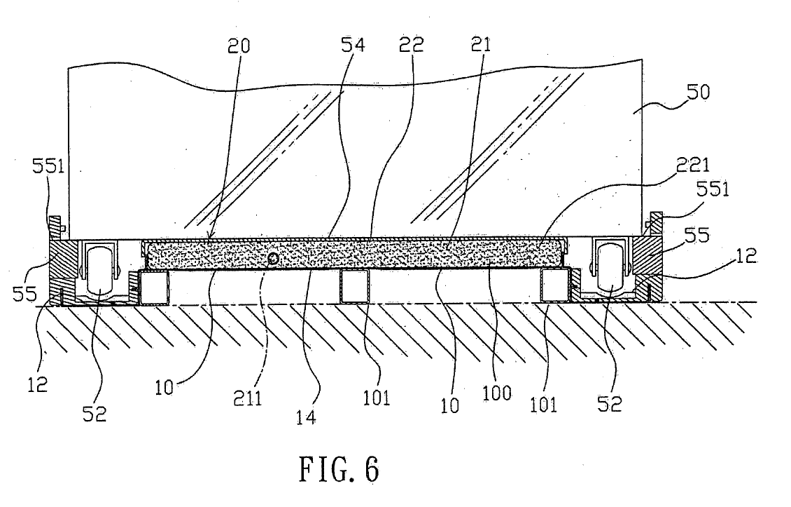

Referring to FIG. 5 and FIG. 6, the upper surface 221 of the upper plate 22 provides for an emplacement of the bottom 54 of the heavy object 50, and the bottom of the heavy object 50 is provided with pulleys 52. Two sides of the base 10 are provided with tracks 12 respectively, and the pulleys 52 are emplaced on the tracks 12. Outsides of the tracks 12 are provided with outer walls 13, 13′ respectively. These two outer walls 13, 13′ are provided with long through-holes 131, 131′ which can be transfixed and locked with soft pads 55 that are located between the neighboring pulleys 52, and the bottom 54 of the heavy object 50 is pressed on upper surfaces of the pads 55.

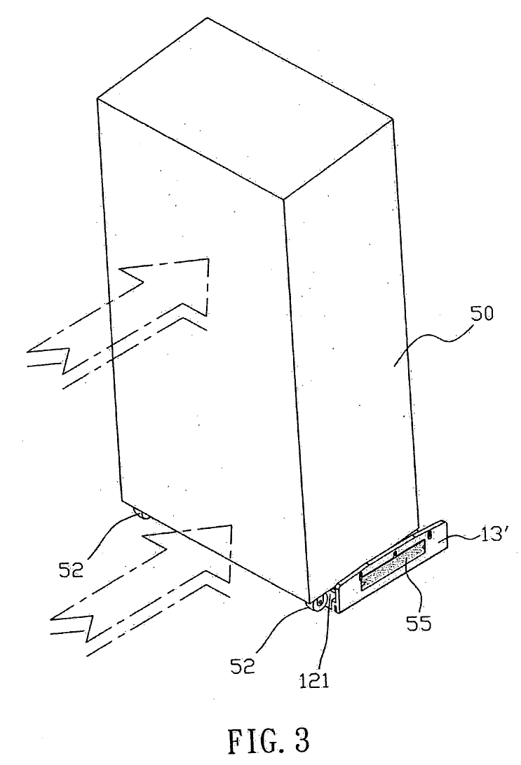

Referring to FIG. 2 and FIG. 3, the groove-shape tracks 12 are located at a left and right sides of the base 10, and front ends of the tracks 12 are provided with slopes 121, such that the pulleys 52 can be slid into the tracks 12 through the slopes 121.

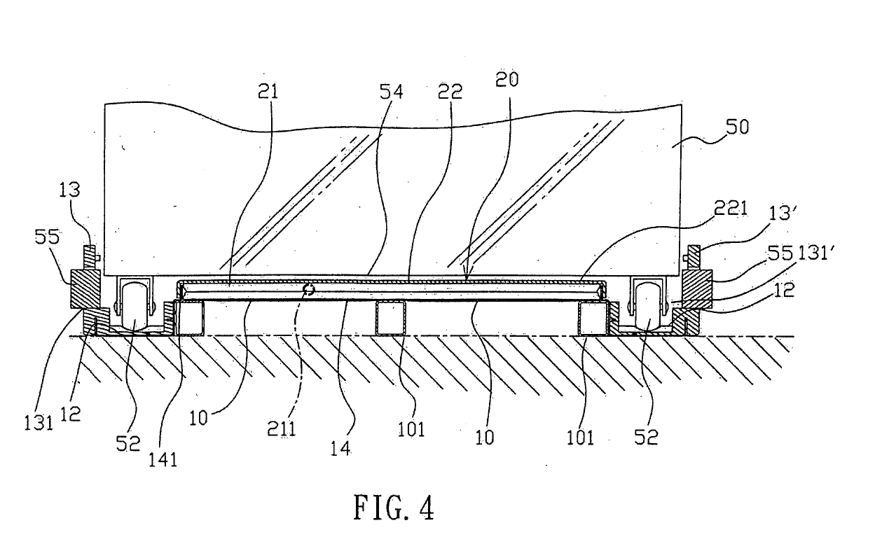

Referring to FIG. 2 and FIG. 4, a side of the air cushion 21 is provided with a valve 211 for air accessing. A wall of the sink 14 is provided with a lower notch 142, and a side of the upper plate 22 is provided with an upper notch 226. The upper and lower notches 226, 142 are corresponding to each other to assemble into a through-hole, and the valve 211 can be extended out of the upper notch 226 and the lower notch 142.

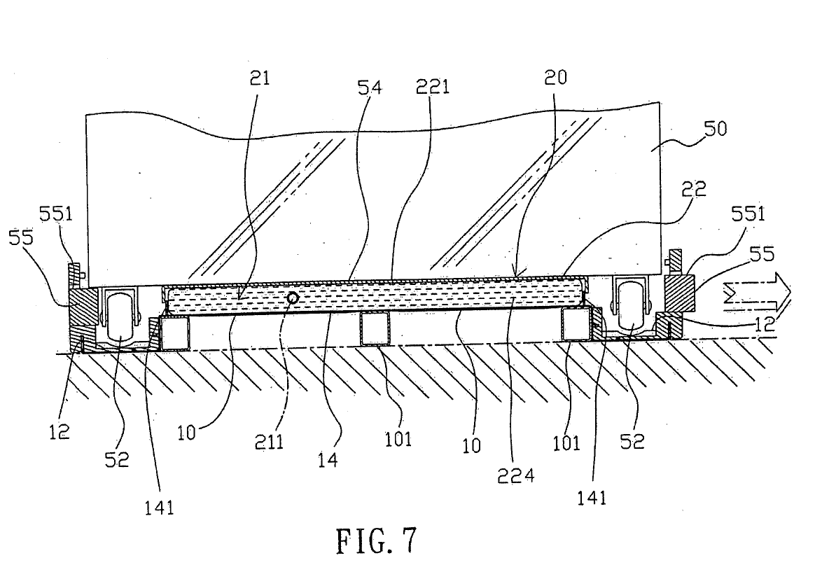

Referring to FIG. 7, it shows another embodiment of the present invention, wherein the air cushion 21 can be also filled with liquid 224 which creates a wave from vibration. The wave is transmitted to the upper plate 22 through the surface of the air cushion 21.

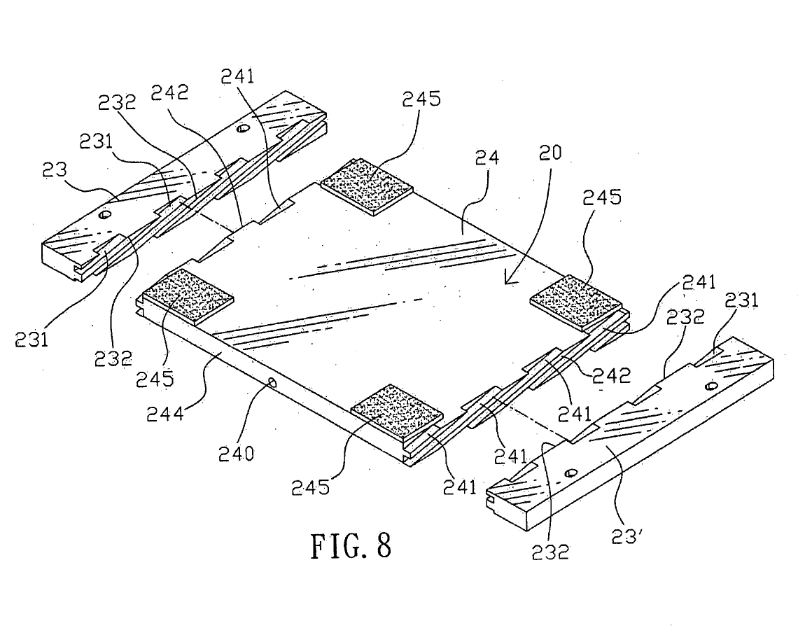

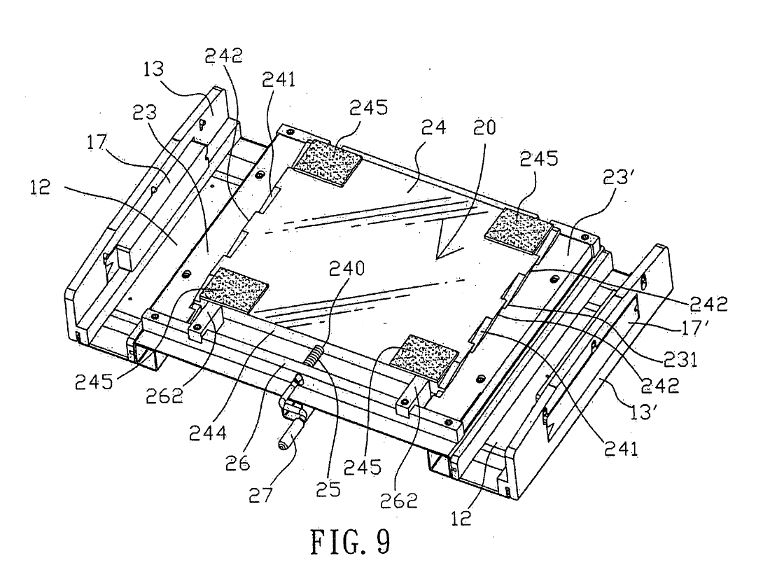

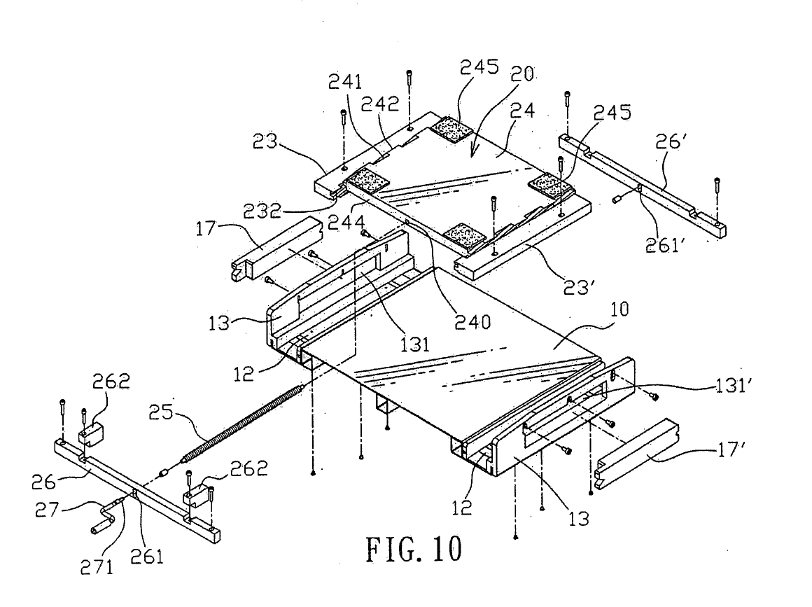

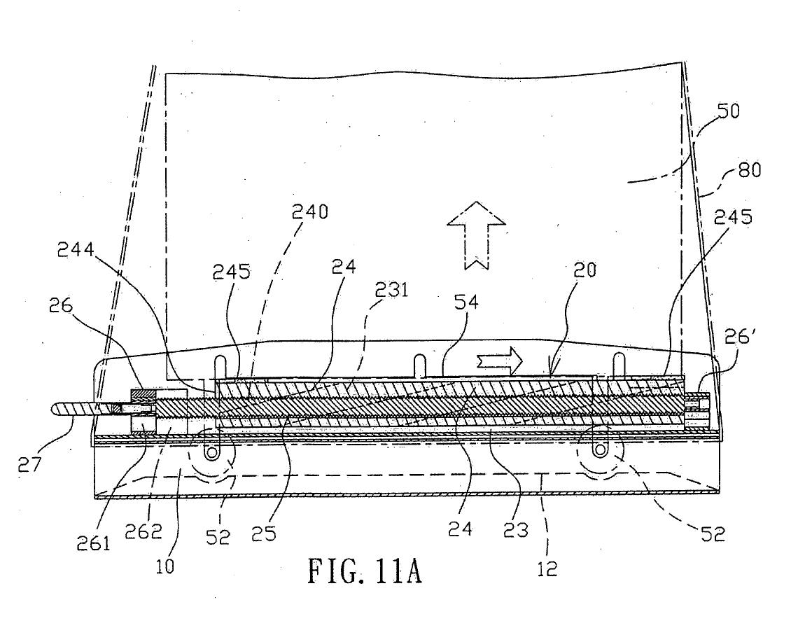

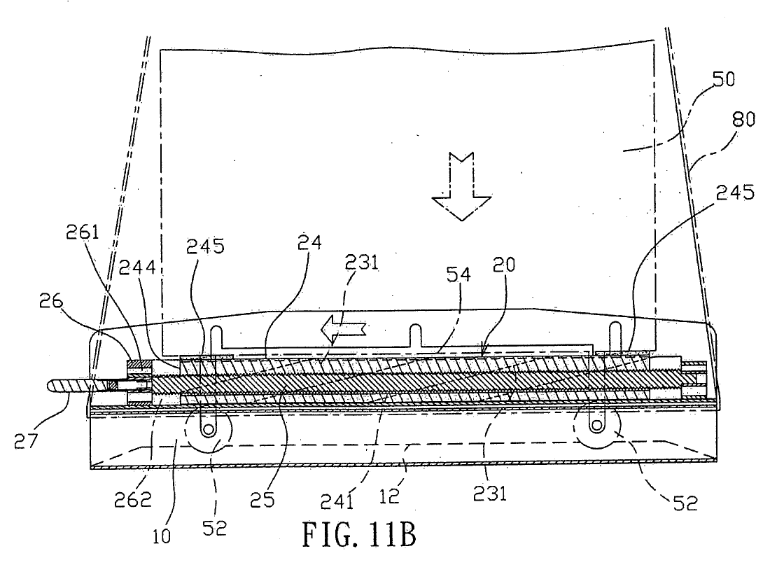

Referring to FIGS. 8, 9, and 10, it shows still another embodiment of the present invention, wherein the elastic assembly 20 includes a left fixing block 23 and a right fixing block 23′ which are fixed at two sides of the surface of the base 10 respectively (as shown in FIG. 10). Inner walls of the left and right fixing blocks 23, 23′ are provided respectively with oblique chutes 231 and oblique projected slide rails 232, with one chute 231 being located next to one projected slide rail 232. On the other hand, two side walls of the upper plate 24 are provided with oblique chutes 241 and oblique projected slide rails 242 respectively. The projected slide rails 242 are slidably connected into the chutes 231 of the left and right fixing blocks. Through forward and backward slidable displacements of the projected slide rails 232, 242 in the chutes 241, 231, the upper plate 24 is controlled to move upward or downward. When the upper plate 24 moves upward, it can push up the heavy object 50; whereas when the upper plate 24 moves downward, the heavy object 50 will be escaped from the upper plate 24. Referring to FIGS. 11A and 11B, the surface of the upper plate 24 is fixed with an elastic cushion 245, and the bottom 54 of the heavy object 50 is pressed and rolled on the elastic cushion 245.

Referring to FIG. 10, a front side of the upper plate 24 is provided with a screw-hole 240 for connecting with a long screw 25, and the surface of the upper plate 24 is provided with the elastic cushion 245. A front lateral bar 26 is fixed at a front end of the base 10, and is provided with a long through-hole 261. A rear lateral bar 26′ is fixed at a rear end of the base 10, and is provided with a long through-hole 261′. A connection end 271 of a rocker stick 27 is loosely transfixed into the long through-hole 261 and is connected to an end of the screw 25; whereas the other end of the screw 25 is loosely connected into the long through-hole 261′ of the rear lateral bar 26′. By rotating the rocker stick 27 clockwise and counterclockwise, the screw 25 can be controlled to drive the upper plate 24 to move forward and backward. When the upper plate 24 moves forward, its height is increased; whereas when the upper plate 24 moves backward, its height is descended (as shown in FIGS. 11A and 11B).

Referring to FIG. 10, two sides of the base 10 are provided with the tracks 12, and the bottom of the heavy object 50 is provided with the plural pulleys 52 which can be attached on the tracks 12, respectively (as shown in FIG. 11A).

Referring to FIG. 10, two sides of the base 10 are provided with the tracks 12 respectively, and the outsides of the two tracks 12 are provided with the outer walls 13, 13′ respectively. These two outer walls 13, 13′ are provided with the long through-holes 131, 131′, such that two soft pads 17, 17′ can be locked into the through-holes 131, 131′.

Referring to FIG. 10, a front rim of the front lateral bar 26 is provided with at least more than one stopping block 262 which is blocked at a front edge 244 of the upper plate 24.

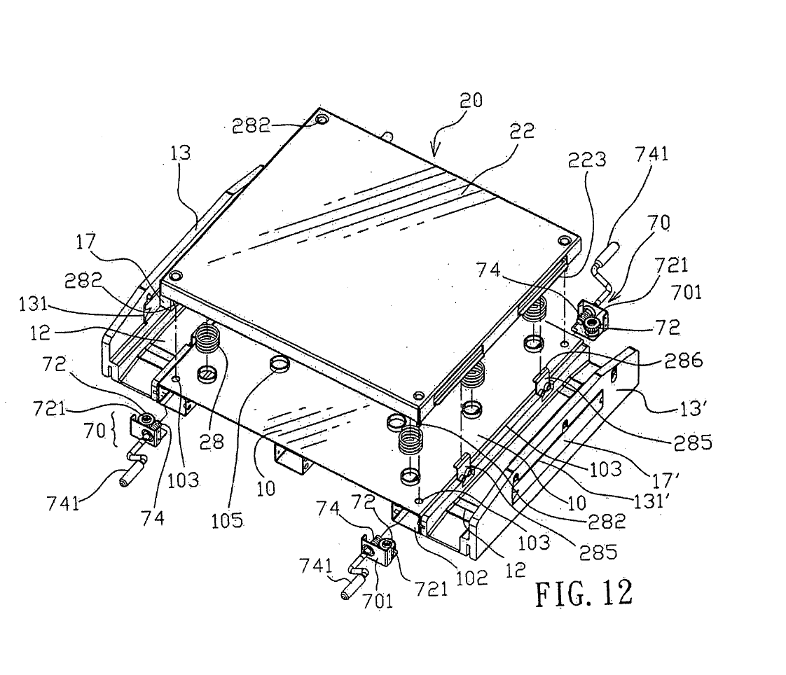

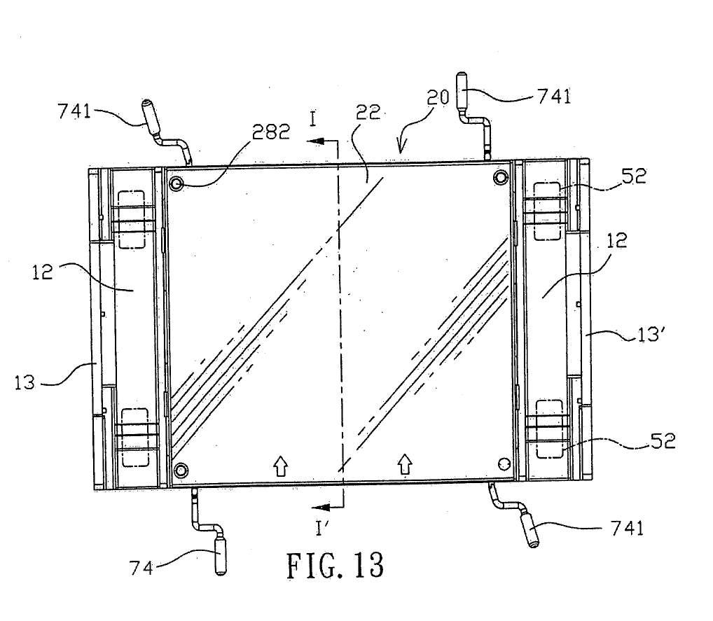

Referring to FIG. 12 and FIG. 13, it shows a further embodiment of the present invention, wherein the elastic assembly 20 includes the upper plate 22, an inner surface of which is connected with a plurality of elastic elements 28, and four corners of which are fixed with screws 282, with lower connection ends of the elastic elements 28 being correspondingly in contact with the surface of the base 10; the base 10, four corners of which are installed with through-holes 103, and a bottom of which is provided with hollow beams 102 beneath the through-holes 103; a worm gear set 70, which is transfixed into the hollow beam 102 and is provided with a worm gear 72 having a screw-hole 721 and being loosely connected at a bottom plate of a bracket 701; and a worm 74, a gear system of which is gnawed with a gear system of the worm gear 72, and which is loosely connected on the bracket 701 having a handle 741. A long screw 282 is transfixed into the through-hole 103 and screwed into the screw-hole 721, and by rotating the worm 74 clockwise and counterclockwise, the worm gear 72 can be controlled to rotate clockwise and counterclockwise, and the long screw 282 can be controlled to ascend and descend in the through-hole 103, along with an ascending and descending of the upper plate 22.

Referring to FIG. 12, a side of the base 10 is fixed with extension pieces 285, upper ends of which are formed with hooks 286. Two sides of the upper plate 22 are provided respectively with flanges 223 which are protruded outward, allowing the hooks 286 to be locked at the flanges 223. When the upper plate 22 is moving upward and downward, the flanges 223 will slide upward and downward along a space below the hooks 286; so as to prevent the upper plate 22 from moving left and right.

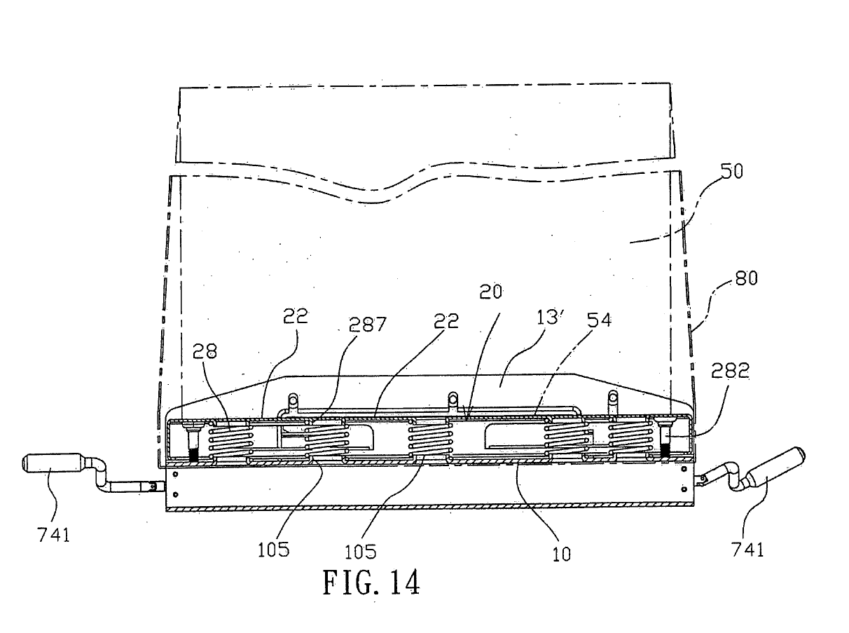

Referring to FIG. 14, an inner surface of the upper plate 22 is provided with a plurality of short sleeves 287, and the surface of the base 10 is provided with a plurality of short sleeves 105. The mutually corresponding short sleeves 287, 105 provide for an emplacement and a positioning of two ends of the elastic element 28.

Referring to FIG. 12, an upper end of the long screw 282 is fixed and assembled at the upper plate 22.

Referring to FIG. 12, two sides of the base 10 are fixed respectively with the tracks 12, the outsides of the tracks 12 are provided respectively with the outer walls 13, 13′ which are installed with the long through-holes 131, 131′, and two soft pads 17, 17′ are locked into the through-holes 131, 131′.

Referring to FIG. 14, the surface of the upper plate 22 provides for the loading of the heavy object 50, and the bottom of the heavy object 50 is provided with the plural pulleys 52 which are attached to the tracks 12 that are fixed at the two sides of the base 10.

Referring to FIG. 4, when an air cushion 21 is not filled with gas or liquid, the air cushion is in a compression state, and a vertical inner wall of an upper plate 22 is slidably connected on an outer wall 141 of a sink 14, at a lower dead point. As shown in FIGS. 2 and 3, pulleys 52 at left and right sides of a heavy object 50 are pushed into two tracks 12 from two slopes 121.

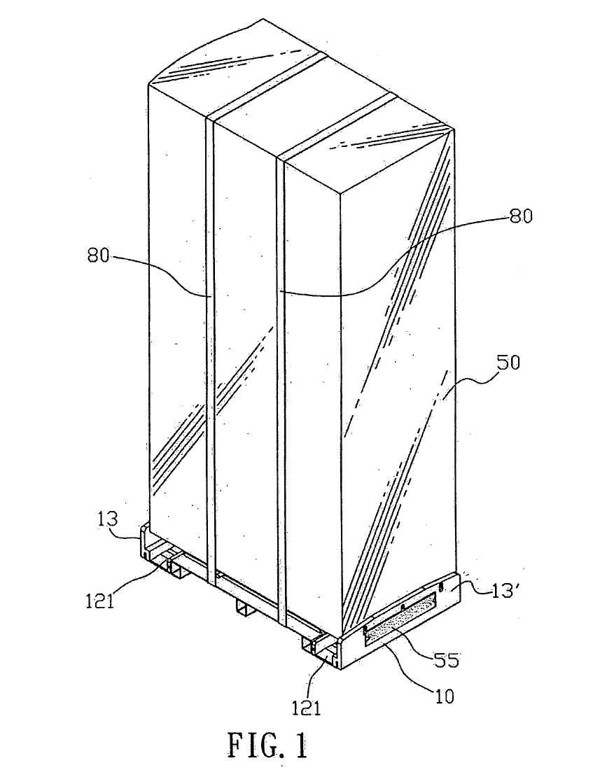

An operator uses an air pump (not shown in the drawing) to fill high-pressure gas 100 into the air cushion 21 through a valve 211. As the air cushion 21 is in a rectangular shape, when it is filled with the gas, a surface of the air cushion 21 is uniformly expanded upward, such that the air cushion 21 can move upward in a sink 14, so as to push up the upper plate 22 horizontally (as shown in FIG. 5), and then the vertical inner walls at a periphery of the upper plate 221 will be sliding upward on the outer walls 141 of the sink 14. When the upper plate 22 pushes up the heavy object 50, such that the heavy object 50 moves upward a certain distance to leave a pre-determined gap T between a bottom 54 of the heavy object 50 and the tracks 12, soft pads 55 with a certain height are then directly transfixed and locked into long through-holes 131, 131′ (as shown in FIG. 2), and are located exactly between the front and rear neighboring pulleys 52. At this time, a part of the high-pressure gas 100 is discharged from the valve 211, until the bottom 54 of the heavy object 50 is gently pressed on surfaces 551 of the pads 55. Therefore, the bottom 54 will be pressed on the upper plate 22 and the surfaces 551 of the pads 55, respectively. As the pad 55 is a foaming material, the surface 551 will not scratch hard on the bottom 54 of the heavy object 50. When the base 10 and the heavy object 50 are fastened together (as shown in FIG. 1) by a fastener 80 like a rope or a tape, and if at this time, the heavy object 50 and the base 10 are all loaded on a vehicle (not shown in the drawing), then vibration force which is formed while the vehicle is moving will be transmitted to the air cushion 21. As the high-pressure gas 100 in an interior of the air cushion 21 is compressible, an effect of vibration absorption is achieved, and the air cushion 21 is formed as an elastic element and transmits elastic force resulting from the vibration force to the upper plate 22 and the heavy object 50 directly. Therefore, during a process of transporting the heavy object 50, the vibration force generated from the movement of the vehicle will be absorbed by the air cushion 21, and the heavy object 50 will not be invaded by the larger vibration force, which further prevents the pulleys 52 from being broken and damaged by other forces, and prevents components in an interior of the heavy object 50 from being damaged.

On the other hand, when the heavy object 50 is to be unloaded from the base 10, the valve 211 will be charged again (as shown in FIG. 5) to expand the air cushion 21 once more. Then, the upper plate 22 is ascended a certain distance, and the heavy object 50 is pushed up a certain distance, which further enables the bottom 54 of the heavy object 50 to be escaped from the surfaces 551 of the pads 55. Therefore, the operator can easily take the pads 55 out of the long through-holes 131, 131′ and then discharge the valve 211 again, enabling the air cushion 21 to descend horizontally in the sink 14. At the same time, the upper plate 22 is descended horizontally too, allowing the plural pulleys 52 to be in contact with the tracks 12 (as shown in FIG. 40), and referring to FIGS. 1 to 3, the operator can push the heavy object 50 out of the base 10, and the pulleys 52 will be rolling along the two tracks 12 and out to a ground from the two slopes 121, thereby enabling the heavy object 50 to be pushed to a place which is positioned by the operator. This procedure can be dispensed with an operation of a weight-lifting vehicle or a crane. Of course, if the positioning place of the heavy object 50 belongs to a ground of intensive vibration, then the heavy object 50 can be positioned on the elastic assembly 20 of the present invention for a long time, and is provided with the vibration-proof effect at the same time. As the pad 55 is made by non-metallic material such as PE foaming material, plastic, and rubber, there will be no hard friction between the surfaces 551 and the bottom 54 of the heavy object 50, which results in that when the heavy object 50 vibrates, left and right sides of the bottom 54 are balanced, so as to prevent the heavy object 50 from shaking excessively due to the vibration. In addition, a bottom of the base 10 is fixed with a plurality of beams 101 to enhance intensity of the entire base 10.

Referring to FIG. 7, the air cushion 21 is not limited to an application to the charging and discharging with gas, and can be also designed as a water sack. By filling in liquid 224 (such as water) from the valve 211, the entire air cushion 21 will be provided with water wave and an effect of vibration absorption like a water bed. The air cushion 21 is similarly expanded and ascends by filling with the liquid 224, and is shrunk in the sink 14 by discharging the liquid 224, such that the heavy object 50 can be easily positioned on the elastic assembly 20 to achieve the vibration-proof effect, and the heavy object 50 can be easily dismantled from the elastic assembly 20 and the base 10.

Referring to FIGS. 8, 9, and 10, it shows another embodiment of the present invention, wherein the elastic assembly 20 can also push up and put down the heavy object 50. The primary principle of action is to use human hands to rock a rocker stick 27 clockwise and counterclockwise for rotating a long screw 25 clockwise and counterclockwise, so as to drive the upper plate 24 to move forward and backward on the screw 25. When the upper plate 24 is moving forward, a plurality of oblique projected slid rails 242 are slidably displaced toward an upper front in chutes 231 of left and right fixing blocks 23, 23′, which also pushes up the upper plate 24 during the process. In the mean time, the heavy object 50 above the upper plate 24 is synchronously pushed up a certain distance (as shown in FIG. 11A). When a horizontal rod of the rocker stick 27 is moved to a position above a long through-hole 261, the upper plate 24 is pushed to the highest position. At this time, the heavy object 50 can be fastened together with the base 10 by a fastener 80, and the pulleys 52 of the heavy object 50 are located above the tracks 12. Next, by locking the soft pads 17, 17′ into the long through-holes 131, 131′ (as shown in FIG. 10), two sides of the bottom 54 of the heavy object 50 can be located on the surfaces of the soft pads 17, 17′, such that a better balance can be achieved when the heavy object 50 vibrates.

When the heavy object 50, the elastic assembly 20, and the base 10 are fastened together, they can be transported or stored. Moreover, four corners of a surface or the entire surface of the upper plate 24 is provided with elastic pads 245 (as shown in FIGS. 11A and 11B) made by rubber material, whereby when the heavy object 50 is loaded on the upper plate 24, the elastic pads 245 will serve as a contact surface between them. As the rubber material of the elastic pads 245 is provided with effects of vibration reduction and vibration proof, when the heavy object 50 is fixed on the upper plate 24 and the base 10, due to the vibration-reduction effect of the elastic pads 245, the vibration-proof effect is achieved in the process of transporting and moving the heavy object 50, in order to prevent the heavy object 50 from being damaged by the vibration.

On the other hand, when the heavy object 50 is unloaded from the elastic assembly 20 (as shown in FIG. 11B), the fastener 80 is removed first, and then the soft pads 17, 17′ are taken out of the long through-holes 131, 131′ (ash shown in FIG. 10). Next, the rocker stick 27 is rocked to rotate the long screw 25 counterclockwise, enabling the upper plate 24 to move backward along the screw 25. In the mean time, the plural projected slide rails 242 will be slidably displaced toward a lower back in the chutes 241 of the left and right fixing blocks 23, 23′ (as shown in FIG. 8). After the front edge 244 is in contact with stopping blocks 262 (as shown in FIG. 11B), the upper plate 24 will stop moving. At this time, the horizontal rod of the rocker stick 27 is located below the long through-hole 261, and the upper plate 24 will move downward, enabling the heavy object 50 to descend synchronously. After the pulleys 52 descend to the two tracks 12, the upper plate 24 will be escaped from the bottom 54 of the heavy object 50; therefore, the heavy object 50 is pushed out of the elastic assembly 20 and the base 10 along the tracks 12, thereby being displaced to a proper place.

Referring to FIGS. 12, 13, and 14, it shows still another embodiment of the present invention, wherein elastic elements 28 are installed between the upper plate 22 and the base 10, and upper and lower connection ends of the elastic elements 28 are all sheathed into short sleeves 287, 105, to form an elastic positioning device. When the bottom 54 of the heavy object 50 is pressed on the surface of the upper plate 22, the elastic elements 28 which are provided with a vibration-absorption effect, are compressed. Then, by rocking (or rotating) handles 741 at four corners of the elastic assembly 20 manually, height of the upper plate 22 above the base 10 can be controlled. By using the fastener 80 (as shown in FIG. 14) to fasten the heavy object 50 on the upper plate 22 and the base 10, the heavy object 50, the elastic assembly 20, and the base 10 are combined together as one body. As shown in FIG. 12, at this time, the soft pads 17, 17′ have been pre-inserted into the long through-holes 131, 131′, and two sides of the bottom 54 of the heavy object 50 are in contact with the surfaces of the soft pads 17, 17′, such that a better balance can be achieved when the heavy object 50 vibrates.

On the other hand, when the heavy object 50 is to be unloaded, the plural handles 741 are rotated counterclockwise after the fastener 80 is dismantled, to drive a worm 74 to rotate, and a gear system of the worm 74 will drive a worm gear 72 to rotate. Then, a fixed screw 282 which is screwed in a screw-hole 721 will move downward in the screw-hole 721 with a manner of gear-system screwing. Therefore, four fixed screws 282 can all be operated to move downward to a pre-determined height, and the soft pads 17, 17′ can be taken out of the long through-holes 131, 131′. Thus, the pulleys 52 of the heavy object 50 will descend and be attached on the two tracks 12 (as shown in FIG. 13), and the upper plate 22 will be escaped from the bottom 54 of the heavy object 50, thereby enabling the pulleys 52 to be slid out of the two tracks 12 and the heavy object 50 to be escaped from the elastic assembly 20 and the base 10.

In order to prevent the upper plate 22 from shaking toward a left and a right upon being loaded with the heavy object 50, flanges 223 (as shown in FIG. 12) which are extended from two side walls of the upper plate 22 can be displaced in a space beneath hooks 286 of extension pieces 285. When the upper plate 22 is not loaded with the heavy object 50, the flanges 223 will be in contact with the hooks 286 due to a free ascending of the upper plate 22.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A control apparatus for carrying a heavy object, comprising:
a base which is connected with a set of elastic assembly that moves upward and downward; and the elastic assembly, an upper plate of which is loaded with the heavy object; by an upward displacement of the elastic assembly, the upper plate pushing up the heavy object, and by a downward displacement of the elastic assembly, the upper plate of the elastic assembly being escaped from the heavy object which is removed from the elastic assembly and the base.

2. The control apparatus for carrying a heavy object according to claim 1, wherein the base is provided with the elastic assembly including an air cushion, an interior space of which is filled with chargeable and dischargeable high-pressure gas, such that volume of which is expanded or compressed at proper time; and the upper plate, which is provided with an upper surface, and which is loosely sheathed on a surface of the air cushion; the air cushion moving upward vertically from being expanded by inflating, enabling the upper plate to ascend vertically to push up the heavy object, whereas the air cushion moving downward vertically from being compressed by deflating, enabling the upper plate to descend vertically to be escaped from a bottom of the heavy object.

3. The control apparatus for carrying a heavy object according to claim 1, wherein a bottom of the base is fixed with a plurality of beams to increase intensity of the entire base.

4. The control apparatus for carrying a heavy object according to claim 2, wherein the upper surface of the upper plate provides for an emplacement of a bottom of the heavy object which is provided with pulleys; two sides of the base being installed respectively with tracks, and the pulleys being located on the tracks; outsides of the tracks being provided respectively with outer walls which have long through-holes for transfixing with soft pads; the soft pads being located between the neighboring pulleys, and the bottom of the heavy object being pressed and rolled on upper surfaces of the soft pads.

5. The control apparatus for carrying a heavy object according to claim 4, wherein the tracks are in a groove-shape and are located at left and right sides of the base; front ends of the tracks being provided with slopes, such that the pulleys are slid into the tracks through the slopes.

6. The control apparatus for carrying a heavy object according to claim 2, wherein a side of the air cushion is provided with a valve for air accessing, a side wall of the base is provided with a lower notch, and a side of the upper plate is provided with an upper notch; the upper and lower notches being mutually corresponding to assemble into a through-hole, and the valve being extended out of the upper notch and the lower notch.

7. The control apparatus for carrying a heavy object according to claim 2, wherein the air-cushion is filled with liquid which generates wave from vibration; the wave being transmitted to the upper plate through the surface of the air cushion.

8. The control apparatus for carrying a heavy object according to claim 1, wherein the elastic assembly includes a left fixing block and a right fixing block which are fixed respectively at two sides of the surface of the base, and inner walls of which are provided respectively with oblique chutes and oblique projected slide rails, with one chute being next to one projected slide rail; and an upper plate, two side walls of which are provided respectively with oblique chutes and oblique projected slide rails, with the projected slide rails being slidably connected into the chutes of the left and right fixing blocks; through a forward and backward slidable displacement of the projected slide rail in the chute, the upper plate being controlled to move upward or downward that if the upper plate moves upward, the heavy object being pushed up by the upper plate and whereas the upper plate moves downward, the heavy object being escaped from the upper plate; a surface of the upper plate being fixed with an elastic pad, and a bottom of the heavy object being pressed on the elastic pad.

9. The control apparatus for carrying a heavy object according to claim 8, wherein a front side of the upper plate is provided with a screw-hole for screwing with a long screw, and a surface of the upper plate is provided with an elastic pad; a front lateral bar being fixed at a front end of the base, and being provided with a long through-hole; a rear lateral bar being fixed at a rear end of the base, and being provided with a long through-hole; a connection end of a rocker stick being loosely transfixed into the long through-hole and being connected with an end of the screw, whereas the other end of the screw being loosely connected into the long through-hole of the rear lateral bar; by rocking the rocker stick clockwise and counterclockwise, the screw being controlled to drive the upper plate to move forward and backward that when the upper plate moves forward, height being increased, and when the upper plate moves backward, the height being decreased.

10. The control apparatus for carrying a heavy object according to claim 8, wherein two sides of the base are provided respectively with tracks and a bottom of the heavy object is provided with a plurality of pulleys which are attached on the tracks, respectively.

11. The control apparatus for carrying a heavy object according to claim 8, wherein two sides of the base are provided respectively with tracks, and outsides of the tracks are provided respectively with outer walls that are provided with long through-holes; two soft pads being locked into the through-holes.

12. The control apparatus for carrying a heavy object according to claim 9, wherein a front rim of a front lateral bar is fixed with at least more than one stopping block that is stopped at a front edge of the upper plate.

13. The control apparatus for carrying a heavy object according to claim 1, wherein the elastic assembly includes an upper plate, an inner surface of which is connected with a plurality of elastic elements, and four corners of which are fixed with screws, with lower connection ends of the elastic elements being correspondingly in contact with a surface of a base; the base, four corners of which are provided with through-holes, and a bottom of which being provided with hollow beams that are beneath the through-holes; and a worm gear set, which is transfixed into the hollow beam; the worm gear set being composed of a worm gear which is provided with a screw-hole and is loosely connected at a bottom of a bracket; and a worm, a gear system of which is gnawed with a gear system of the worm gear, and which is loosely connected on the bracket having a handle; the long screw being transfixed into the through-hole and screwed into the screw-hole, and by rotating the worm clockwise and counterclockwise, the worm gear being controlled to rotate clockwise and counterclockwise, and the long screw being controlled to ascend and descend in the through-hole, with the upper plate ascending and descending synchronously along with the long screw.

14. The control apparatus for carrying a heavy object according to claim 13, wherein a side of the base is fixed with extension pieces, upper ends of which are formed with hooks; two sides of the upper plate being provided respectively with flanges that are protruded outward, and the hooks being locked at the flanges;
when the upper plate moving upward and downward, the flanges sliding upward and downward along a space beneath the hooks to prevent the upper plate from moving left and right upon moving upward and downward.

15. The control apparatus for carrying a heavy object according to claim 13, wherein an inner surface of the upper plate is provided with a plurality of short sleeves, and a surface of the base is provided with a plurality of short sleeves, with these mutually corresponding short sleeves providing an emplacement and a positioning of two ends of the elastic element.

16. The control apparatus for carrying a heavy object according to claim 13, wherein an upper end of the long screw is fixed and assembled at the upper plate.

17. The control apparatus for carrying a heavy object according to claim 13, wherein two sides of the base are fixed respectively with tracks, outsides of the tracks are provided respectively with outer walls having long through-holes; two soft pads being locked into the through-holes.

18. The control apparatus for carrying a heavy object according to claim 13, wherein a surface of the upper plate provides for a loading of the heavy object, and a bottom of the heavy object is provided with a plurality of pulleys that are attached to the tracks fixed at two sides of the base.
